(19) United States
(12) Patent Application Publication
(10) Pub. No.: US 2006/0068082 A1
(43) Pub. Date: Mar. 30, 2006

(54) Method of electrostatic deposition

(75) Inventors: Johannes Marra, Eindhoven (NL); Stephen John Battersby, Haywards Heath (GB); Dirkjan Bernhard Van Dam, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/529,129

(22) PCT Filed: Aug. 8, 2003
(86) PCT No.: PCT/IB03/03642

§ 371 Date: Mar. 22, 2005

(30) Foreign Application Priority Data
Sep. 25, 2002 (EP) 02256671.5

(51) Int. Cl. B05D 1/04; B05D 1/12

(52) U.S. Cl. 427/58; 427/458; 427/180; 427/162

(57) ABSTRACT

A process for the electrostatic deposition, in particular of LCD color filters (9) or spacer material (15) on a substrate (1) of a display, involves the successive electrostatic deposition of the red, green and blue color material (8) and the black matrix material (14) or spacer material. The aerosolized material having a unipolar charge in the deposition chamber experiences an electrostatic force of controlled magnitude that is directed (preferably antigravitationally) towards the substrate surface by means of an (externally) applied electrostatic field.

The invention relates to a method of depositing aerosolized particles from a carrier gas stream on a first side of a substrate comprising the steps of electrically charging said particles and directing said charged particles via at least one outlet towards the substrate. This so-called “electrostatic deposition” has many applications. One of them is the coating of different closely spaced areas in a display device to produce a color filter. Another application within the display area, especially within LCD's, is the electrostatic deposition of spacing means.

The invention further relates to display devices, manufactured by means of such a method.

U.S. Pat. No. 5,066,512 shows such a method, in which a color filter is produced by selectively charging selected areas (picture electrodes) on a substrate to which droplets of opposite charge are selectively attracted to and deposited on said areas. In the embodiment shown however only droplets that are present near the centerline of flow (from a nozzle) are deposited on the substrate, making the method very inefficient. Moreover the electrostatic forces are generated by electric fields generated between adjacent picture electrodes only and therefore have less impact than the (mechanical) blowing force, leading to inaccurate particle deposition (in particular at smaller dimensions of the picture electrodes).

Similar remarks apply to the method of GB 2,304,916 in which spacing means are deposited between the picture electrodes of the display device. Moreover due to gravity the particles intend to follow a path not strictly defined by said electric fields generated between the picture electrodes.

The invention has a. o. as its object to overcome the objections as mentioned above. To this end in a method according to the invention an electric field between the substrate and a deposition electrode near the outlet is maintained during deposition.

By controlling the carrier gas flow and the electrical field strength between the substrate and the deposition electrode the charged particles follow strictly determined pathways, which reduces the loss of material to be deposited and on the other hand provides the possibility of accurate deposition. Since the pathways are now controlled substantially completely by the carrier gas flow and the electrical field strength between the substrate and the deposition electrode, the (mechanical) blowing force is no longer necessary. Especially the influence of gravity and consequently any deposition of contaminating dust particles onto the (tacky) substrate can be avoided by an upside-down positioning (anti-gravitational) of the substrate with respect to the known methods.

The electric field is not necessarily generated by means of the deposition electrode and electrodes on the substrate (display) itself. In a preferred embodiment the other side of the substrate is coupled to a further electrode for generating the electric field between the substrate and the deposition electrode. This further electrode may be in (electrical) contact with the substrate, but may also be capacitively coupled to the substrate, e.g. when the electrode is embedded in a further plate (e.g. a deposition table).

Especially for realizing color filters or deposition of spacer material the particles are deposited on predefined parts of the substrate by introducing a locally higher electrical field strength at the area of the predefined parts.

These and other aspects of the invention are apparent from and will be elucidated with reference to the embodiment described hereinafter.

In the drawing:

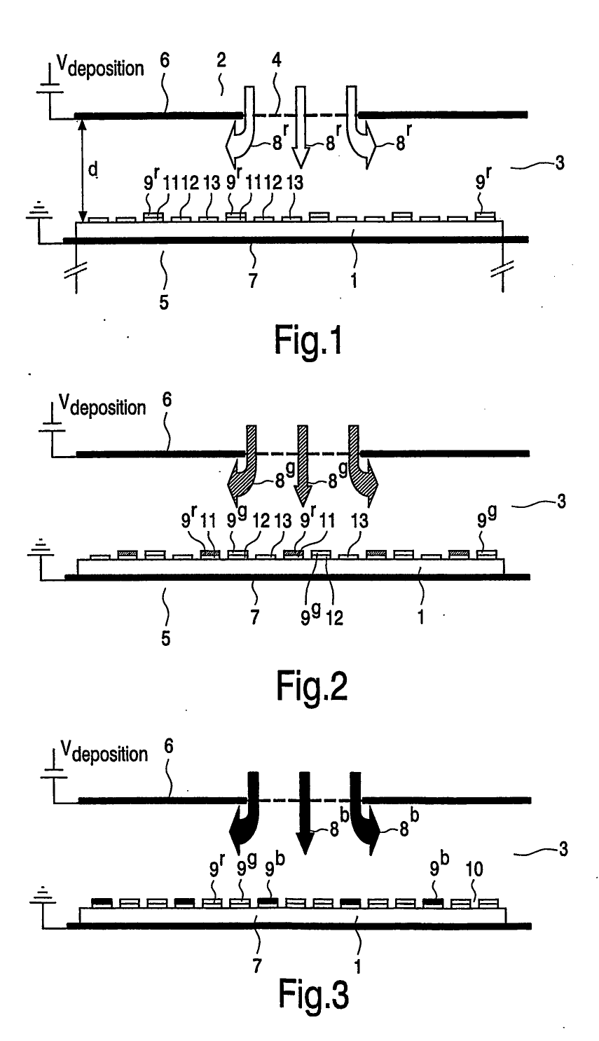

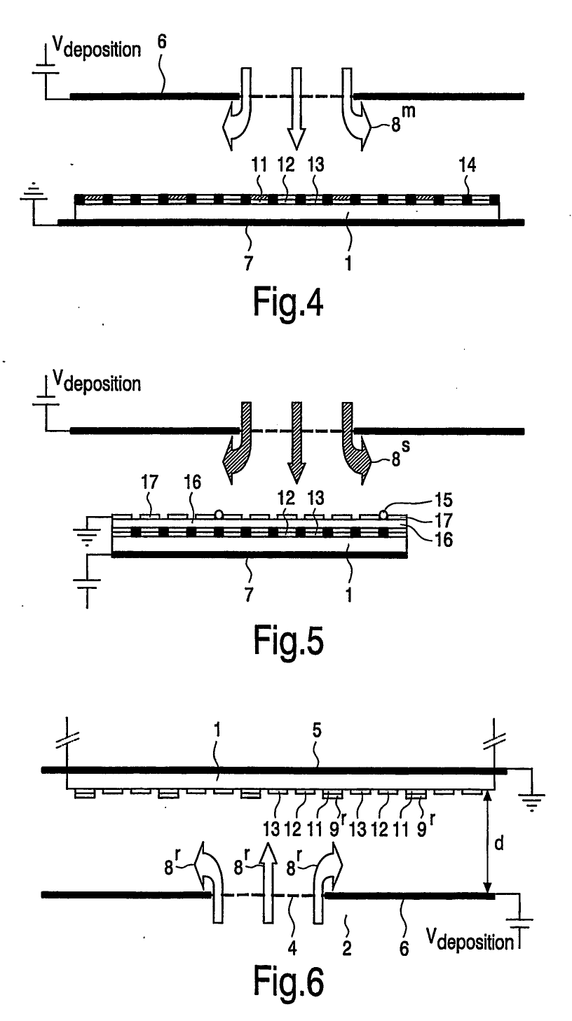

FIGS. 1-5 show a substrate for a liquid crystal display device during several stages of its manufacturing and

FIG. 6 shows a preferred way of depositing particles

The Figures are diagrammatic and not drawn to scale. Corresponding elements are generally denoted by the same reference numerals.

FIG. 1 shows on a support 5 a substrate 1, which may be a glass or plastic substrate, for e.g. a liquid crystal display device, comprising electrodes 11, 12, 13 in a deposition apparatus. In the apparatus solid aerosolised particles or liquid aerosolised particles can be generated and dispersed in a carrier gas stream and then size-classified. In a next step the particles are electrostatic charged (unipolar) in a high-voltage corona section After having been concentration-homogenised in an expansion chamber the charged aerosolised particles are deposited onto a substrate.

The apparatus, which is not part of the present invention, therefore comprises a.o.

an aerosol generator (not shown) for the aerosolisation of solid particles, which transfers dry powder particles from a compacted state into an airborne dispersed state in a carrier gas stream enabling the dispersion of powders with particles sizes down to well below 1 micrometer in diameter. Size classification of the produced aerosol is performed by a dust filter (either a simple mechanical filter or a dielectric filter),which removes the larger particles and only transmits the smaller particles.

a nozzle for dispersing liquid aerosols into a first solvent-saturated gas stream. The aerosolised liquid can contain dispersed solid particles like very small pigment particles or larger spacer particles and potentially other dissolved materials like polymeric materials or e.g. sol-gel precursor materials. Size classification may be performed by means of a baffle plate, after which the liquid aerosol, present in a dispersed state in the first gas stream, is mixed with a second gas stream. The volume flow of the streams, the temperature, and the size of the expansion chamber a.o. determine the evaporation kinetics that affects the size of the liquid aerosol particles—the evaporation kinetics and the size and/or composition of the liquid aerosol particles can thus be tuned.

A high-voltage corona charging section, e.g. featuring a high-voltage needle electrode and a counter-electrode.

An expansion chamber for the concentration homogenisation of the charged aerosol

The charged aerosol particles (indicated by arrows 8 in FIG. 1) leave the expansion chamber (indicated by 2 in FIG. 1) and enter into the deposition chamber (indicated by 3 in FIG. 1) via an outlet provided by a porous gauze 4 in a high-voltage (metal) deposition electrode (plate) 6 which is set at a voltage V_{deposition}. The substrate 1 (the support 5) for the aerosol to be deposited on is placed at a distance d from the deposition electrode (plate) 6 and positioned substantially in parallel with the deposition electrode (plate) 6. The deposition chamber 3 is physically bounded by the substantially parallel-positioned sides of the substrate 1 (the support 5) and the deposition electrode (plate) 6 facing each other but left substantially open to the outside environment at all other sidesthus the carrier gas stream carrying the aerosol can freely flow to the entire side and along the entire side of the whole substrate 1.

The substrate 1 (the support 5) is preferably coupled to a further (metal) electrode 7 set at a potential such that the charged particles are always drawn towards the substrate by means of the electric field existing between the substrate 1 and the deposition electrode 6. If the electric field is sufficiently high substantially all aerosol particles (indicated by arrows 8^{r} in FIG. 1) are removed from the carrier gas stream and deposited onto the substrate 1 during their residence time inside the deposition chamber 3.

In this example the side of the substrate 1 facing the deposition electrode (plate) 6 carries a matrix structure of ITO electrodes 11, 12, 13. First a red part of the color filter is deposited by introducing red charged particles 8^{r}, obtained via the aerosolisation of a liquid color filter ink. Each individual ITO electrode either has a surface area that, in the device to be realized, matches that of a display pixel area (active matrix) or a number of display pixel areas (passive matrix). A first voltage (V₁) is imposed on ITO electrodes 11 while a different second voltage (V₂) is imposed on all other ITO electrodes (electrodes 12, 13). The sign and magnitude of the voltages V₁ and V₂ with respect to V_{deposition} are chosen such that substantially all aerosolized ink droplets 8^{r} are deposited on the electrode regions 11 whereon a voltage V₁ is imposed, resulting in a red colored color filter part 9^{r}. Preferably V₂ is chosen the same as the voltage on the further electrode 7 e.g. earth potential.

In the next step (FIG. 2) the above process is repeated for the green colored color filter part 9^{g}, by imposing the first voltage (V₁) on ITO electrodes 12 while the second voltage (V₂) is imposed on all other ITO electrodes (electrodes 11, 13). In the next step (FIG. 3) the process is repeated for the blue colored color filter part 9^{b}, by imposing the first voltage (V₁) on ITO electrodes 13 while the second voltage (V₂) is imposed on all other ITO electrodes (electrodes 11, 12). In this way, a pattern of different deposited colors is obtained, with some space 10 left in between the individual colours.

The space 10, which is not covered with conductive ITO, according to a further aspect of the invention is selectively covered with aerosolized black-matrix material 8^{m} by imposing a (high) voltage (V₃) on the further electrode 7 while all ITO electrodes 11, 12, 13 on the substrate 1 are connected to the voltage V₂. The sign and magnitude of the voltages V₂ and V₃ with respect to V_{deposition} are chosen such that the charged aerosolized black matrix particles 8^{m} are more strongly attracted towards the regions with voltage V₃ than towards the regions with voltage V₂. In this way, the surface regions between the ITO electrodes on the substrate acquire such a voltage that the resulting electric field is very strongly directed towards the regions and locally attains its highest strength between the ITO electrodes 11, 12, 13. So deposition occurs only in the space between the ITO electrodes. To obtain such electric fields V₂ and V₃ preferably are very different from each other.

If necessary, after the deposition, the resulting color filter is subjected to UV radiation and a thermal curing. In case the color filter is deposited on the passive plate of an active matrix liquid crystal display device, the ITO electrode structure as described above is first deposited onto said passive plate, which involves ITO deposition and a subsequent structuring by means of a photolithographic step. The entire color filter is then, if necessary, covered with an organic planarisation layer 16 or an isolating layer (see FIG. 5). The planarisation layer is then again covered with a (segmented) common ITO electrode structure 17 which, in turn, is covered by a LC orientation top layer.

In case the color filter is deposited on the active plate of an active matrix liquid crystal display device, the colour filter may be realized either underneath the TFT structures/electrodes, or on top of the TFT structures/electrodes.

In the first case the color filter material is deposited on auxiliary electrodes which need not necessarily coincide with the picture electrodes to be formed. In the latter case the ITO electrodes connected to the TFTs can be directly used as the above-mentioned ITO electrode surfaces whereon the deposition of the aerosolized colour filter material occurs. A self-aligned deposition process is then attained. To ensure that the resistivity of the color filter (including the planarisation layer) is much smaller than the resistivity of the LC material (to prevent image retention) separate ITO electrodes may be deposited on top of the color filter that are connected to the TFT/ITO electrodes underneath the colour filter by means of vials. The color filter layer is then effectively short-circuited between a top and a bottom ITO electrode.

The advantages of the above described deposition process are that about 80-85% of the colored ink solutions is effectively deposited in the color filter while less than 10% of the colored inks are effectively deposited while using conventional spin coating. This implies a very substantial cost saving. Moreover the aerosol process described allows a very uniform colour filter thickness to become deposited across a large surface area and lends itself for scaling up and thus for the coating of very large-sized substrates. Also in the method according to the invention the substrate surface is positioned upside down during deposition which makes the colour filter layer much less susceptible to become contaminated by depositing dust particles. This is shown for the step of FIG. 1 in FIG. 6, in which all reference numerals have the same meaning.

The method as described allows the patterned deposition of charged aerosolized particles in the ˜0.1-10 μm size range. So after realizing the color filter (in this example) patterned (local) deposition of spacer particles is possible on parts of the substrate, located between regions covered by ITO electrodes, which is shown in FIG. 5. The aerosol is generated from a dilute dispersion of e.g. substantially monodisperse-sized glass spacers (with f.i. 5 μm diameter) in a suitable liquid like iso-propanol. In case the spacer particles are deposited on the passive plate of an active matrix liquid crystal display, the segmented common ITO electrode 17 is set at a voltage V₂ so that the electric field generated by the voltage V_{deposition} on the deposition electrode (plate) 6 and the (high) voltage (V₃) on the further electrode 7 now guides the particles 8^{s} to the required positions in between adjacent segments of the ITO common electrode 17 (as shown by spacers 15). In case the spacer particles are deposited on the active plate of an active matrix liquid crystal display, the voltage V₂ is uniformly imposed on all ITO picture electrodes on the active plate so that the electric field generated by the voltage V_{deposition} on the deposition electrode (plate) 6 and the (high) voltage (V₃) on the further electrode 7 now guides the particles 8^{s} to the required positions in between the areas covered by ITO picture electrodes. Spacer particles can also be deposited on substrates outside the areas covered by ITO picture electrodes in passive matrix liquid crystal devices. By e.g. grounding thepicture electrodes 11, 12, 13 we can deposit the spacers 15 outside of the pixel area.

The protective scope of the invention is not limited to the embodiments described, while the invention is also applicable to other display devices. For instance the electrostatic deposition of spacers need not be combined with the electrostatic deposition of a color filter, but is applicable to monochrome display devices as well.

The method can also be used in other fields than display technology for instance for the homogeneous coating of substrates. In case such a homogeneous coating is applied onto a substrate plate, e.g. a glass plate or a (thin) plastic plate in general no conducting layers will be present on the substrate plate, but the electric field is generated then by a (separate) further electrode. In this way, very homogeneous thin films like sol-gel layers, photo-resist layers, scattering particle layers, etc. can be deposited onto e.g. glass or plastic at a very economic use of aerosol material.

Another possible application of the inventive method comprises deposition of polymer spacer particles that are coated with an electrically conductive layer e.g. for touch switch applications.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A method of depositing aerosolized particles from a carrier gas stream on a first side of a substrate comprising the steps of
electrically charging said particles
directing said charged particles in the carrier gas stream via at least one outlet towards the substrate while maintaining an electric field between the substrate and a deposition electrode near the outlet.

2. A method according to claim 1 in which the deposition electrode comprises the outlet.

3. A method according to claim 1 in which the charged particles in the electrical field move anti-gravitationally.

4. A method according to claim 1 in which the other side of the substrate is coupled to a further electrode for generating the electric field between the substrate and the deposition electrode.

5. A method according to claim 1 in which the particles are deposited on predefined parts of the substrate by introducing a locally higher electric field strength at the area of the predefined parts.

6. A method according to claim 5 for manufacturing a color filter in which each color is deposited by giving electrodes associated with said color a voltage different from the voltages for electrodes associated with other colors.

7. A method according to claim 6 in which black matrix material is deposited between the said electrodes by giving all said electrodes substantially the same voltage while depositing the black matrix material.

8. A method according to claim 6 in which the said electrodes are picture electrodes.

9. A method according to claim 5 for depositing spacing means between the picture electrodes of the display device by giving all picture electrodes substantially the same voltage while depositing the spacing means.

10. A method according to claim 5 for depositing spacing means, the substrate being provided with an electrode having openings to provide the locally higher field strength

11. A display device comprising a color filter manufactured by means of the method according to claim 6.

12. A display device comprising at least two substrates, the substrates being kept at a mutual distance by spacing means, the spacing means being manufactured by means of the method according to claim 9.
